(19) United States
(12) Patent Application Publication
(10) Pub. No.: US 2007/0271795 A1
(43) Pub. Date: Nov. 29, 2007

(54) Blade safety insert

(75) Inventors: Richard R. Brandon, Bradford, PA (US); Gregg A. Reynolds, Bradford, PA (US)

Correspondence Address: HODGSON RUSS LLP;THE GUARANTY BUILDING, 140 PEARL STREET, SUITE 100, BUFFALO, NY, 14202-4040, US

(73) Assignee: W.R. Case & Sons Cutlery Company

(21) Appl. No.: 11/441,611

(22) Filed: May 26, 2006

(51) Int. Cl. B26B 3/06

(52) U.S. Cl. 30/152

(57) ABSTRACT

A blade safety insert for use in combination with a folding knife having a blade cavity and a pivotally connected blade for movement between open and closed positions. The blade has a tang, and the blade safety insert is removably fitted in the blade cavity to engage the tang of the blade and block closing movement of the blade beyond a pre-selected partially open position that is at an acute angle relative to the blade cavity.

### BACKGROUND

A typical folding knife or pocket knife includes a handle having a blade cavity. A blade having a cutting edge and a tang is pivotally connected to an end of the handle (with a pivot). The folding knife also has a spring that is connected to the handle. The blade can be pivoted between an open position in which the blade extends in a direction away from the handle, and a closed position in which the blade is folded into the blade cavity. The spring biases the blade into the closed position such that when the blade is in the closed position, the folding knife can be safely handled or carried in, for example, a pocket.

As anyone who has ever handled a folding knife can attest, care always must be taken when handling folding knives, especially when the blade or blades are in the open position. Care also must be taken when the blades are moved from the open position to the closed position. This is because the fingers of the person handling the folding knife can be cut if they are positioned between the blade and the blade cavity when the spring drives the blade into the closed position. This automatic spring-driven closing of the blade is oftentimes unpredictable, which increases the risk of injury to the person handling the folding knife.

In other situations, the blades of a folding knife are intentionally left in a partially open position. For example, retailers frequently display folding knives with the blades in a partially open position, so that the folding knife is visually appealing. Also, collectors often display their folding knives with the blades in a partially open position. Indeed, at collector meetings folding knives with the blades thereof in a partially open position are frequently passed from one collector to the next. In each of these situations, there is a risk that the partially open blades will accidentally move into the closed position and cause injury in the process.

In addition, folding knives are often sold in product packaging with the blades in the partially open position. This product packaging is usually very stiff. Thus, removing the folding knife from the product packaging is difficult and somewhat dangerous, because as the folding knife is being worked out of the product packaging the partially open blades can close on the fingers of the customer.

Thus, there is a need to eliminate the problems associated with the blades of folding knives undesirably moving from a partially open position to the closed position.

### SUMMARY

The present invention is a blade safety insert. The blade safety insert is adapted to be used in combination with a folding knife or a pocket knife having a blade cavity. The blade safety insert comprises an elongated body having a first end having a first contact shoulder and an opposed second end having a second contact shoulder, a first liner side and an opposed second liner side, a cavity side and an opposed lifting side. First and second support legs having contact surfaces extend from the cavity side. The blade safety insert can have a curved contour along its length that matches the contour of the handle of the folding knife into which the blade safety insert is to be removably positioned.

In one embodiment the folding knife has a first blade having a tang pivotally connected to a first end of the handle for movement between an open position and a closed position relative thereto. The folding knife also has a second blade having a tang pivotally connected to an opposite second end of the handle for movement between an open position and a closed position relative thereto. The blade cavity is adapted to receive the first and second blades when they are folded into a fully closed position. The folding knife handle has a spring connected to it that biases the first blade and the second blade into the closed position. The blade safety insert is removably fitted within the blade cavity when the blades are in the open position. The first and second contact shoulders of the blade safety insert engage the tangs as the first and second blades are rotated toward the closed position. The blade safety insert thus blocks closing movement of the first and second blades beyond pre-selected partially open positions. In these pre-selected positions, the first and second blades are at acute angles relative to the blade cavity and handle, and the insert prevents inadvertent closing movement of the first and second blades. The tangs of the first and second blades hold the blade safety insert in the blade cavity when in the partially open positions. The blade safety insert has a length, and the acute angles the first and second blades make with the blade cavity can be varied by appropriately changing the length of the blade safety insert.

The blade safety insert can be made such that it can be removably fitted in the cavities of folding knives that have a single blade, two opposed blades as described above and two blades pivotally connected to the same end of the handle. In other embodiments, the blade safety insert can be made such that it can be removably fitted in the cavities of folding knives that have more than two blades, for example, a folding knife having two blades pivotally connected to a first end of the handle and one blade pivotally connected to an opposite second end of the handle. In other embodiments, the blade safety insert can be made with protrusions to increase the friction or wedging fit it makes with the liners of the folding knife. In yet other embodiments, the blade safety insert can have a formation, and the tangs of blades can abut against the formation.

Thus, one of the advantages of the blade safety insert is that after it has been introduced in the folding knife blade cavity, the blades of the folding knife cannot snap into the closed position, and this makes the folding knife suitable for handling, display and retail sales. Another advantage is that when the blade safety insert is releasably positioned in the blade cavity, the folding knife can be readily positioned in product packaging.

### BRIEF DESCRIPTION OF THE DRAWINGS

The blade safety insert of this invention is illustrated in the drawing figures, of which:

FIG. 1 is a perspective view of a blade safety insert releasably fitted in a blade cavity of a folding knife with the blades in a partially open position.

FIG. 2 is a diagrammatic view of a blade safety insert spaced a distance from the blade cavity wherein the blades are in the fully open position.

FIG. 3 is a sectional front elevational view of the folding knife taken along cut line III-III of FIG. 1, with the blade safety insert releasably fitted in the blade cavity.

FIG. 4 is a fragmentary, sectional, front elevational view taken along cut line V-V of FIG. 1 showing a first end of the blade safety insert and a first end of the folding knife.

FIG. 5 is a fragmentary, sectional, front elevational view taken along cut line IV-IV of FIG. 1 showing a second end of the blade safety insert and a second end of the folding knife.

FIG. 6 is a perspective view of the blade safety insert.

FIG. 7 is a front elevational view of the blade safety insert.

FIG. 8 is a left end elevational view of the blade safety insert.

FIG. 9 is a right end elevational view of the blade safety insert.

FIG. 10 is a top plan view of the blade safety insert.

FIG. 11 is a perspective view of a second embodiment of the blade safety insert.

FIG. 12 is a front elevational view of the second embodiment of the blade safety insert.

FIG. 13 is a left end elevational view of the second embodiment blade safety insert.

FIG. 14 is a right end elevational view of the second embodiment blade safety insert.

FIG. 15 is a top plan view of the second embodiment of the blade safety insert.

FIG. 16 is a sectional front elevational view of a folding knife having two opposed blades with the second embodiment of the blade safety insert releasably fitted in the blade cavity thereof.

FIG. 17 is a perspective view of a third embodiment of the blade safety insert.

FIG. 18 is a front elevational view of the third embodiment of the blade safety insert.

FIG. 19 is a top plan view of the third embodiment of the blade safety insert.

FIG. 20 is a right end elevational view of the third embodiment of the blade safety insert.

FIG. 21 is a perspective view of a fourth embodiment of the blade safety insert positioned in a folding knife having two blade cavities.

FIG. 22 is a diagrammatic view of the folding knife having two blade cavities with the blades in the fully open position and the fourth embodiment of the blade safety insert.

FIG. 23 is a perspective view of the fourth embodiment of the blade safety insert.

FIG. 24 is a front elevational view of the fourth embodiment of the blade safety insert.

FIG. 25 is a top plan view of the fourth embodiment of the blade safety insert.

FIG. 26 is a left end elevational view of the fourth embodiment of the blade safety insert.

FIG. 27 is a right end elevational view of the fourth embodiment of the blade safety insert.

### DETAILED DESCRIPTION

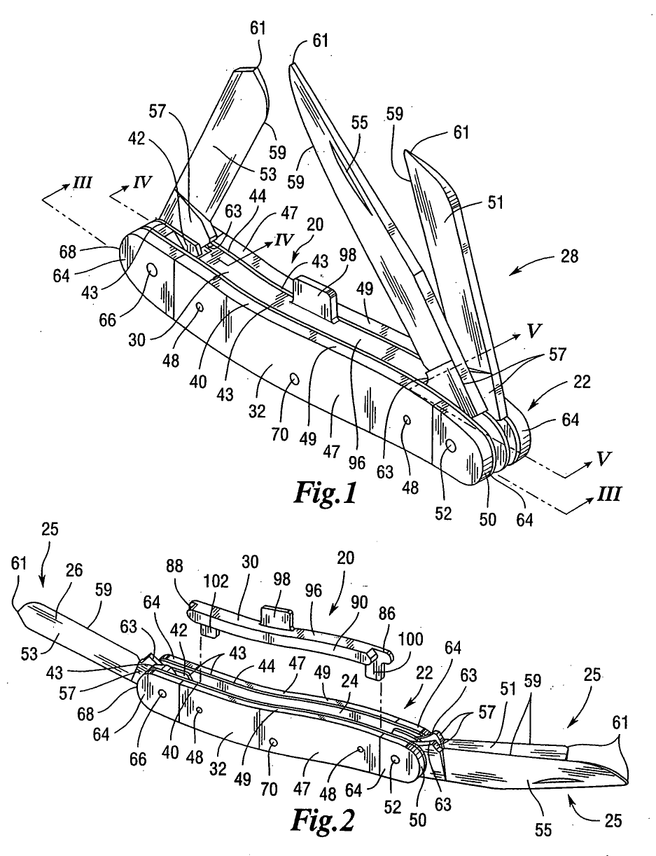

As shown generally in FIGS. 1-10, one embodiment of the blade safety insert of the present invention is generally designated 20. The blade safety insert 20 is adapted for use in combination with a folding knife or pocket knife 22 (hereinafter folding knife 22) having a blade cavity 24 and a first blade 51, a second blade 53 and a third blade 55. As shown diagrammatically in FIG. 2, the blade safety insert 20 can be releasably fitted in the blade cavity 24 when the first, second and third blades 51, 53 and 55, respectively, are in a fully open position 25. As shown in FIG. 1, after the blade safety insert 20 has been releasably fitted in the blade cavity 24, the first blade 51, second blade 53 and third blade 55 are closed until they contact the blade safety insert 20 and can close no more. The first, second and third blades 51, 53 and 55 are thus held in the partially open positions 28 upon contacting the blade safety insert 20.

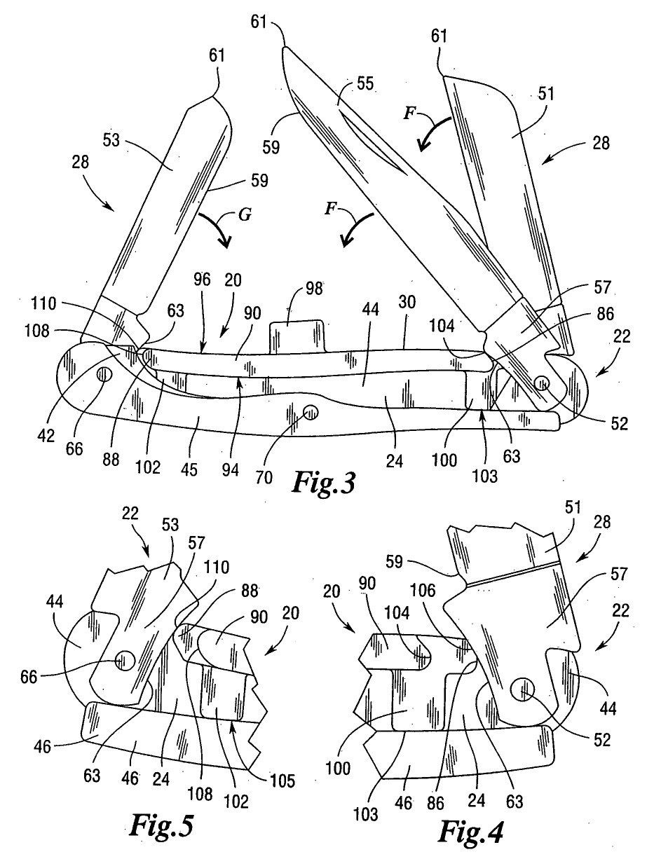

As shown in FIGS. 1 and 2, the folding knife 22 the blade safety insert 20 is used in combination with has a handle 32 including a first liner 40, a second liner 42 and a third liner 44, with the second liner 42 positioned between the first and third liners 40, 44, respectively. Each of the first, second and third liners 40, 42, 44, respectively, has a liner edge commonly designated 43. As shown in FIGS. 3-5 a first spring 45 is positioned between the first liner 40 and the second liner 42, and as shown in FIGS. 2, 4 and 5, a second spring 46 is positioned between the second liner 42 and the third liner 44. The folding knife handle 32 has side members 47 connected to the first and third liners 40, 44, respectively, with pins 48. The side members 47 can comprise bone, wood, plastic, metal or other suitable materials. As shown in FIGS. 1 and 2, the liner edges 43 are substantially flush with the side members 47.

FIGS. 1 and 2 also show the folding knife 22 has a first end 50 including a first pivot 52 to which the first blade 51 and third blade 55 are pivotally connected. The folding knife 22 has a second end 68 opposite the first end 50 including a second pivot 66 to which the second blade 53 is pivotally connected. Each of the first, second and third blades 51, 53 and 55, respectively, has an edge 59, a point 61, and a tang 57 having a spring side 63. The tangs 57 of the first and third blades 51, 55, respectively, and the first, second and third liners 40, 42, and 44, respectively, have pivot openings through which the first pivot 52 extends. The ends of the first pivot 52 are positioned in bolsters 64. The bolsters 64 can comprise steel, nickel, brass or other suitable materials. In this manner, the first and third blades 51, 55, respectively, are pivotally connected to the folding knife handle 32.

As shown in FIGS. 3-5, the folding knife 22 is provided with first and second springs 45, 46, respectively, for biasing the tangs 57 of the first, second and third blades, 51, 53 and 55, respectively. Accordingly, at the second end 68 of the folding knife 22, the tang 57 of the second blade 53, the first, second and third liners 40, 42, and 44, respectively, and the first spring 45, all have a pivot opening in through which the second 66 pivot is positioned. The ends of the second pivot 66 extend into bolsters 64, and in this manner the second blade 53 is pivotally connected to the handle 32. As shown in FIGS. 2 and 3-5, the blade cavity 24 is generally between the first and third liners 40, 44, respectively, the first and second springs 45, 46, respectively, and the tangs 57.

As shown in FIGS. 1-5, a central pin 70 is provided. The central pin 70 extends through the side members 47, the first and second springs 45, 46, respectively, and the first, second and third liners, 40, 42 and 44, respectively. The central pin 70 connects the first spring 45 and the second spring 46 to the folding knife handle 32.

When the blade safety insert 20 is not positioned in the blade cavity 24, the folding knife 22 is operable between a fully open position 25, as shown in FIG. 2, and a closed position (not shown) wherein the first, second and third blades 51, 53 and 55, respectively, occupy the blade cavity 24. The first spring 45 serves to rotate the third blade 55 into the closed position when the third blade 55 is at an acute angle relative to the blade cavity 24. The second spring 46 serves to rotate the first blade 51 and second blade 53 into the closed position when they are at an acute angle relative to the blade cavity 24. In particular, as the third blade 55 is rotated from the fully open position 25 in a direction toward the closed position, that is, counterclockwise as viewed in FIG. 2, the third blade 55 makes an acute angle with the blade cavity 24 and the handle 32. As closing continues, the third blade 55 eventually makes a more acute angle with the blade cavity 24, at which angle the closing of the third blade 55 becomes automatic, driven by the first spring 45 driving tang 57 of the third blade 55 into the closed position. In a similar manner, the opposed first blade 51 and second blade 53 are rotated in a direction toward the closed position, each of the first and second blades 51, 53, respectively, makes an acute angle with the handle 32. As closing continues, the first blade 51 and second blade 53 each eventually makes an acute angle with the blade cavity 24. As closing continues, the tangs 57 of the first blade 53 and the second blade 53 are biased by the second spring 46 into the closed position. The above-described spring-driven closing of the first, second and third blades 51, 53 and 55, respectively, occurs rapidly and unexpectedly, and this can cause undesirable injury to a person handling the folding knife 22. Folding knives are well known to those having ordinary skill in the art.

The blade safety insert 20 advantageously eliminates the possibility of injury to a person handling folding knife 22 with the blades thereof in a partially open position. One of the preferred embodiments of the blade safety insert 20 is generally shown in FIGS. 2-10. The blade safety insert 20 has an elongated body 30 including a first end 86 and an opposed second end 88. The blade safety insert 20 includes a first liner side 90 and an opposed second liner side 92, a cavity side 94 and an opposed lifting side 96. In one of the preferred embodiments, the insert 20 comprises plastic or resin and has an integral tab 98 extending from the lifting side 96. The blade safety insert 20 can be formed to have the tab 98 such that the blade safety insert 20 and tab 98 are a one piece construction. As will be described in greater detail presently, in use the tab 98 advantageously provides for a way to safely and repeatedly introduce and remove the blade safety insert 20 from the blade cavity 24. The insert 20 also has a width designated W in FIG. 9. The width W is less than the distance that separates the first and third liners 40, 44, respectively, from one another. When the blade safety insert 20 is positioned in the blade cavity 24, the first liner side 90 abuts the first liner 40, and the second liner side 92 abuts the pocket knife third liner 44.

As shown in FIGS. 3-10, the insert 20 has first and second support legs, 100, 102, respectively, that extend from the insert cavity side 94, and that can be therewith, such that the blade safety insert 20 and first and second support legs 100, 102, respectively are of a one piece construction. As shown in FIG. 7, the first support leg 100 is spaced a distance designated C from the insert first end 86, and the second support leg 102 is spaced the distance D from the insert second end 102. The first support leg 100 is flush with the insert second liner side 92, and the second support leg 102 is flush with the insert second liner side 92. The first and second support legs 100, 102, respectively, advantageously decrease the amount of material required to manufacture the insert 20, thus decreasing production costs. FIG. 7 also shows that the first support leg 100 has a length, designated L1 that is greater than the length, designated L2, of the second support leg 102. As shown in FIG. 1, the folding knife handle 32 has a contour along its length, and the blade safety insert 20 has a contour along its length designated H in FIG. 7. The differing lengths of the first and second support legs 100, 102, respectively, support the blade safety insert 20 such that the lifting side 96 thereof is flush with the handle 32, as shown in FIG. 1. In other embodiments, the blade insert 20 can be otherwise shaped so that it can be introduced into virtually any shaped blade cavity. For example, the blade safety insert can be straight for use with a folding knife having a straight handle.

Also, as shown in FIGS. 3-4 and 6-9, the first support leg 100 has a first contact surface 103, and the second support leg 102 has a second contact surface 105. When the insert 20 is positioned in the blade cavity 24, the first and second contact surfaces 103, 105, respectively, contact the second spring 46.

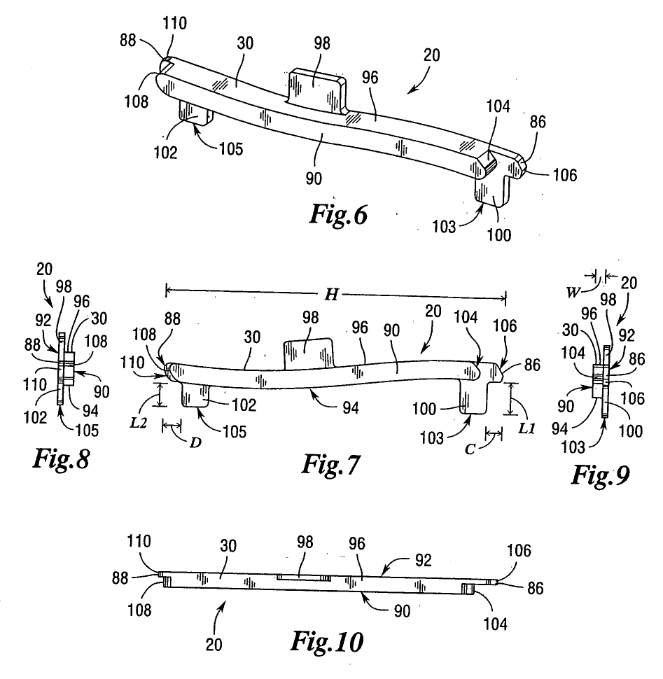

The first end 86 of the insert 20 has a first contact shoulder 104 and a second contact shoulder 106, with the first contact shoulder 104 being recessed or offset relative to the second contact shoulder 106, as shown in FIGS. 6-10. The second end 88 of the insert 20 has a third contact shoulder 110 and a fourth contact shoulder 108, with the fourth contact shoulder 108 being recessed or offset from the third contact shoulder 110. The amount that the first contact shoulder 104 and the second contact shoulder 106 are recessed or offset relative to one another controls the acute angle the first blade 51 and the third blade 55 make relative to one another and make with the blade cavity 24. Similarly, the amount the fourth contact shoulder 108 is recessed relative to the third contact shoulder 110 controls the acute angle that the second blade 53 makes with the blade cavity 24. In addition, the length H of the insert 20 can be varied to change the acute angles. Thus, the blade safety insert 20 blocks the closing movement of the first blade 51, second blade 53 and third blade 55 beyond pre-selected partially open positions of acute angles relative to the blade cavity 24. The acute angles can thus be advantageously varied to satisfy any desired angle of partially open blades.

As previously mentioned, as the third blade 55 is closed, at some point the closing thereof becomes automatic when the first spring 45 biases the tang 57 thereof into the closed position. In one of the preferred embodiments, the first contact shoulder 104 is recessed a sufficient distance such that the tang 57 of the third blade 55 is driven into the first contact shoulder 104 by the first spring 45, as shown in FIG. 3. Similarly, the second and third contact shoulders 106, 110, respectively, are each recessed a sufficient amount such that the tangs 57 of the first blade 51 and the second blade 53 are driven into the second contact shoulder 106 and third contact shoulder 110, respectively, by the second spring 46. Thus, the blade safety insert 20 is held in the blade cavity 24 by the tangs 57 of the first, second, and third blades, 51, 53 and 55, respectively, that are driven into the blade safety insert 20 by the first spring 45 and the second spring 46.

As described above, the length H of the blade safety insert 20 can be varied to change the acute angles that the first, second and third blades 51, 53 and 55, respectively, make with the handle 32. For example, if the elongated body 30 were to be shortened, then the first, second and third blades 51, 53 and 55, respectively would make smaller acute angles with the blade cavity 24. When the first, second and third blades 51, 53 and 55, respectively, are at such smaller acute angles relative to the blade cavity 24, the first and second springs 45, 46, respectively, force on the tangs 57, causing the tangs to apply force on the insert 20.

In addition, as is well known to those having ordinary skill in the art, the first blade 51, second blade 53 and third blade 55 can be maintained in a partially open position, due to friction forces between the tang 57 of the third blade 55 and the first spring 45, and friction forces between the tangs 57 of the first blade 51 and second blade 53 and the second spring 46. The blade safety insert 20 can be removably fitted in the blade cavity 24, and the first blade 51, second blade 53 and third blade 55 can be folded in a direction toward the closed position in the manner described above. The first, second and third blades 51, 53 and 55, respectively, are each at an acute angle with respect to the blade cavity 24 when they make contact with the blade safety insert 20. The tangs 57 contact the blade safety insert 20 and the first blade 51, second blade 53 and third blade 55 are held in the partially open position by frictional forces between the tang 57 of the third blade 55 and the first spring 45, and the tangs of the first blade 51 and second blade 53 and the second spring. Thus, in this embodiment, the first, second and third blades 51, 53 and 55 are not spring biased against the blade safety insert 20, but are held in the partially open position by frictional forces, and the blade safety insert 20 is held in the blade cavity 24, because the tangs 57 prevent the removal of the blade safety insert 20 from the blade cavity 24.

To assemble the knife 22 and blade safety insert 20 the first, second and third blades 51, 53 and 55 preferably are in the fully open position 25, as shown in FIG. 2. The blade safety insert 20 is then removably positioned in the blade cavity 24. Introduction of the blade safety insert 20 can be manual by use of the tab 98 or automatically in, for example, an automated assembly line. The contact surface 103 of the first support leg 100 abuts against the second spring 46, and the contact surface 105 of the second support leg 102 also abuts against the second spring 46, as shown in FIGS. 4 and 5. As shown in FIG. 3, the first and third blades 51, 55, respectively are folded or pivoted counterclockwise as indicated by arrows F. FIG. 3 also shows the second blade 53 folded or pivoted clockwise as indicated by arrow G.

As folding continues, the tang 57 of the third blade 55 eventually makes an acute angle with the handle 32 and blade cavity 24. The third blade 55 is driven by the first spring 45 into the first contact shoulder 104 of the blade safety insert 20, such that the spring side 63 of the tang 57 contacts the first contact shoulder 104, as shown in FIG. 3. The blade safety insert 20 obstructs any additional closing of the third blade 55, and the third blade 55 is thus locked against the blade safety insert in the partially open position 28, as shown in FIGS. 1 and 3. In a similar manner, the opposed first and second blades 51, 53, respectively are folded or rotated from the fully open position 25 in a direction toward the handle 32. The first blade 51 and second blade 53 eventually make acute angles with the handle 32. The second spring 46 drives the first blade 51 into the second contact shoulder 106, and the second spring 46 drives the second blade 53 into the third contact shoulder 110, as shown in FIGS. 1, 4 and 5. The spring side 63 of the tang 57 of the first blade 51 abuts against the second contact shoulder 106, as shown in FIG. 4, and the spring side 63 of the tang 57 of the second blade 53 abuts against the third contact shoulder 110, as shown in FIG. 5.

After the blade safety insert 20 has been removably introduced into the blade cavity 24 in the above-described manner, the tangs 57 of the first, second and third blades 51, 53 and 55, respectively, prevent the blade safety insert 20 from falling out of the blade cavity 24, and the blade safety insert 20 prevents the first, second and third blades 51, 53 and 55, respectively, from moving into the fully closed position. As a result, the first, second and third blades 51, 53 and 55 of the folding knife 22 are advantageously held in the partially open position 28 shown in FIGS. 1 and 3. The blade safety insert 20 can be removed and reused by rotating the first, second and third blades 51, 53 and 55, respectively, in the opposite direction, to positions permitting grasping the tab 98 of the blade safety insert 20 and lifting the blade safety insert 20 out of the blade cavity 24.

The blade safety insert 20 described herein can, in addition to the plastic and resin described above, be made of metal, bone, wood, rubber, other suitable materials and combinations thereof.

One of the advantages associated with having the blade safety insert 20 removably fitted in the blade cavity 24 is that the folding knife 22 can be handled without any of the first, second and third blades 51, 53 and 55, respectively, snapping shut on the fingers of a person handling the folding knife 22. Another advantage is that a consumer can remove the folding knife 22 from product packaging without the risk of the first, second and third blades 51, 53 and 55, respectively, closing. Another advantage of the blade safety insert 20 is that it increases safety because folding knives 22 equipped with the blade safety insert 20 can be displayed on store shelves with a reduced risk of a customer being cut by the first blade 51, second blade 53 or third blade 55 snapping or otherwise moving into a closed position. Another advantage of the blade safety insert 20 is that when the blades are in the partially open position 28, the blade safety insert 20 can be easily introduced into product packaging that has recesses for accommodating blades in the partially open position. In addition, the blade safety insert 20 advantageously provides for increased safety when a customer opens the product packaging to remove the folding knife 22, because none of the first, second or third blades 51, 53 and 55, respectively, can snap closed on the fingers of the customer.

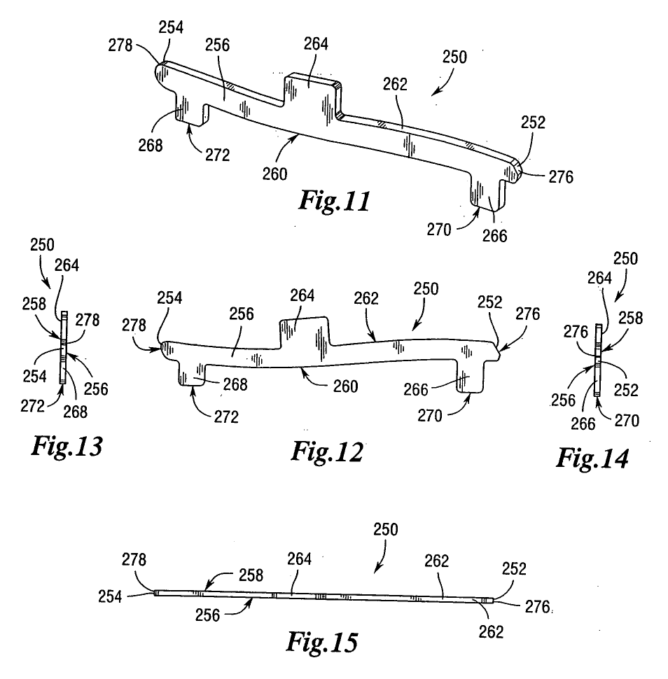

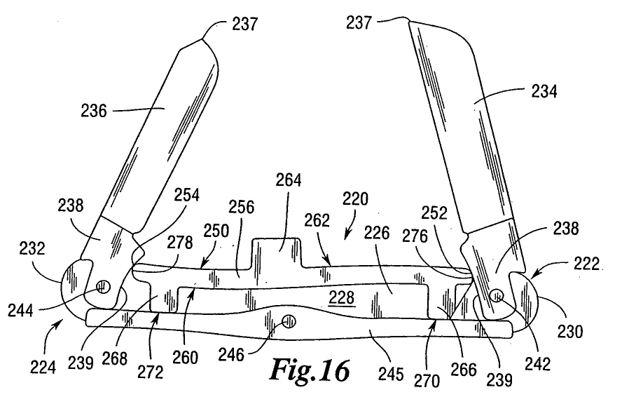

A second embodiment of the blade safety insert 220, shown generally in FIGS. 11-16, is for use in combination with a two-bladed folding knife 222 having opposed first and second blades, 234, 236, respectively. FIG. 16 shows a folding knife 222 having a first end 230 and a second end 232, a handle 224, a first liner (not shown) and a second liner 228. The folding knife 222 has a blade cavity 226. The first blade 234 has a tip 237 and a tang 238, with the tang 238 having a tang contact surface 239, and the tang 238 is pivotally connected to the first end 230 with a first pivot 242. The second blade 236 has a tip 237 and a tang 238, and the tang 238 has a tang contact surface 239, and the second blade 236 is pivotally connected to the second end 232 with a second pivot 244. A spring 245 is connected to the folding knife 222 with a spring pin 246 that extends through the folding knife 222 in a known manner. The spring 245 contacts the tangs 238 of the first and second blades 234 and 236, respectively, and biases the first and second blades 234 and 236, respectively, into the closed position, and also biases them into an open position. The two-bladed folding knives are well known to those having ordinary skill in the art.

The second preferred embodiment of the blade safety insert 220 is shown generally in FIGS. 11-15. The blade safety insert 220 has a first end 252 and an opposed second end 254. The blade safety insert 220 includes a first liner side 256 and an opposed second liner side 258, a cavity side 260 and an opposed lifting side 262. The insert 220 has a tab 264 extending from the lifting side 262. The insert 220 has first and second support legs, 266, 268, respectively, that extend from the insert cavity side 260 and that can be integrally formed therewith. The insert 220 and the first and second support legs, 266, 268, respectively, can also be formed as a one piece construction. The first support leg 266 and second support leg 268 are substantially flush with the first and second liner sides 256, 258, respectively. The first support leg 266 has a first contact surface 270, and the second support leg 268 has a second contact surface 272. When the insert 220 is positioned in the blade cavity 226, the first and second contact surfaces 270, 272, respectively, contact and are supported on the spring 245.

The first end 252 has a first contact shoulder 276 and the second end 254 has a second contact shoulder 278. When the blade safety insert 220 is positioned in the cavity 226, the first and second blades 234, 236, respectively, can be closed until the tang contact surfaces 239 abut against the first and second contact shoulders 276, 278, respectively, as shown in FIG. 16. The first blade 234 and the second blade 236 are held in the partially open position in the manner described above in connection with the first embodiment.

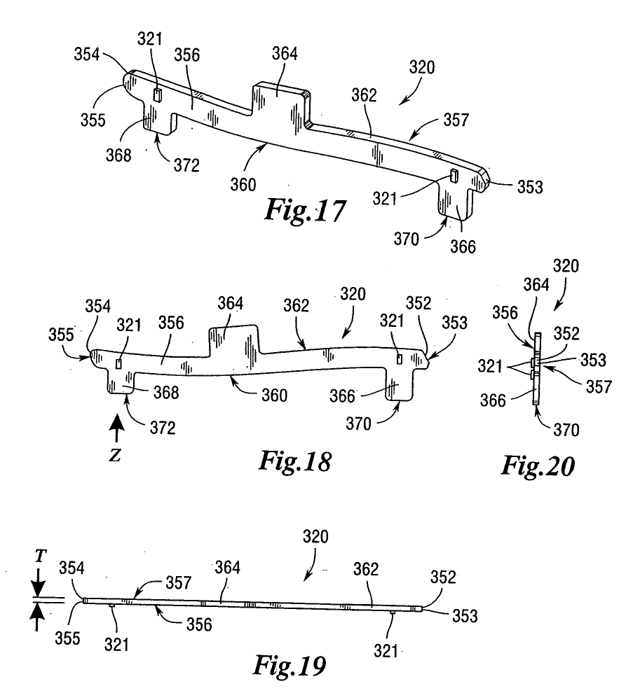

In a third embodiment, shown in FIGS. 17-20, the blade safety insert 320 is advantageously formed with at least one protrusion 321, and preferably two protrusions 321, as shown in FIGS. 17-18. The blade safety insert 320 and the protrusions 321 can be formed as a one piece body. The blade safety insert 320 can be used in combination with a single bladed folding knife having a handle with a blade pivotally connected to the handle, and the handle having opposed liners that define a blade cavity. Single blade folding knives and their construction well known to those having ordinary skill in the art. The blade safety insert 320 has a first end 352 having a first contact shoulder 353, and an opposed second end 354 having a second contact shoulder 355. The blade safety insert 320 includes a first side 356 from which the protrusions 321 extend, and an opposed second side 357, a cavity side 360 and an opposed lifting side 362. The insert 320 has a tab 364 extending from the lifting side 362. The insert 320 includes first and second support legs 366, 368, respectively, that extend from the insert cavity side 360. The first support leg 366 has a first contact surface 370, and the second support leg 372 has a second support surface 372. The insert 320 can be a one piece construction.

The first support leg 366 and second support leg 368 are substantially flush with the second side 357 of the blade safety insert 320. The first side 356 of the blade safety insert 320 has two protrusions 321, as shown in FIGS. 17-20. As shown in the FIGS. 17 and 18, each of the protrusions 321 has a generally rectangular shape, with the long sides of the rectangle extending in a vertical direction, indicated by arrow Z in FIG. 18. A width, designated T and shown in FIG. 19, of the blade safety insert 320 is less than the combined width of the blade safety insert 320 and protrusion 321. Once introduced into the blade cavity the blade safety insert 320 is advantageously held in the blade cavity by a wedge fit. In particular, the wedge fit exists between the second side 357 of the blade safety insert 320 and one of the opposed handle liners, and the protrusions 321 and the other of the opposed handle liners. Thus, the protrusions 321 cause the blade safety insert 320 to be frictionally wedged in the blade cavity. The blade safety insert 320 can be removed from the blade cavity by applying a manual lifting force on the tab 364. It is to be understood that the protrusion 321 can be embodied to have other shapes, for example, a circle, a dot, a polygon, a triangle or a curve. It is to be understood that a single protrusion 321 can extend from the blade safety insert 320 and that the protrusions 321 could, in another embodiment, extend from the second side 357 of the blade safety insert 320.

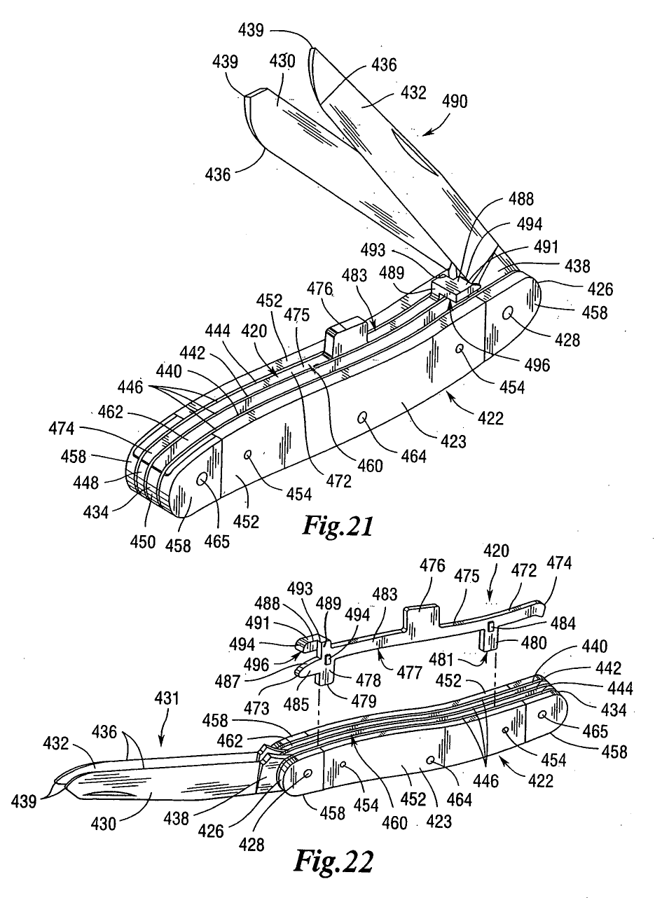

A fourth embodiment of a blade safety insert 420 is shown generally in FIGS. 21-27. In this embodiment, the blade safety insert 420 is for use with a folding knife 422 that has first and second blade cavities 460, 462, respectfully, as shown in FIG. 22. As shown in FIG. 21 and 22, the folding knife 422 has a handle 423 with a first end 426 and an opposed second end 434. A pivot 428 extends through the handle 423 proximal the first end 426. A first blade 430 and a second blade 432 are pivotally connected to the pivot 428. The first blade 430 and the second blade 432 have edges 436, tangs 438 and points 439. As shown in FIGS. 21 and 22, the folding knife 422 has a first liner 440, a second liner 442 and a third liner 444, with the second liner 442 positioned between the first and third liners 440, 444, respectively. The second liner 442 has the same dimensions as the first and third liners, 440, 444, respectively. Each of the first, second and third liners, 440, 442, 444, respectively, has a liner edge commonly designated 446 that extends from the first end 426 to the second end 434 of the handle 423. A first spring 448 is positioned between the first liner 440 and the second liner 442, and a second spring 450 is positioned between the second liner 442 and the third liner 444. In addition, the folding knife handle 423 has side members 452 connected to the first and third liners 440, 444, respectively, with pins 454. As shown in FIGS. 21 and 24, the liner edges 446 are substantially flush with the side members 452.

The first, second and third liners 440, 442, and 444, respectively, have pivot openings (not shown) through which the pivot 428 is positioned. The pivot 428 extends into bolsters commonly designated 458. In this manner, the first and second blades 430, 432, respectively are pivotally connected to the folding knife handle 423. As described above in connection with the first embodiment, the first spring 448 is for biasing the tang 438 of the first blade 430, and the second spring 450 is for biasing the tang of the second blade 432.

As shown in FIGS. 21 and 22, a central pin 464 extends through the side members 452, the first and second springs 448, 450, respectively, and the first, second and third liners, 440, 442 and 444, respectively. The central pin 464 and an end pin 465, which is proximal the second end 434 of the handle 423, connect the first spring 448 and the second spring 450 to the folding knife handle 423. The first and second blades, 430, 432, respectively, can each be rotated on the pivot 428 between a fully open position 431, as shown in FIG. 22, and a closed position (not shown).

As shown in FIG. 22, the first blade cavity 460 is defined by the second liner 442, the third liner 444, the first blade tang 438 and the first spring 448. The second blade cavity 462 is defined by the second liner 442, the first liner 440, the second blade tang 438 and the second spring 450. In the closed position (not shown), the first blade 430 is positioned in the first blade cavity 460, and the second blade 432 is positioned in the second blade cavity 462. Two bladed folding knives 423 are well known to those having ordinary skill in the art.

The blade safety insert 420, shown in FIGS. 21-27, includes an elongate body 472 having a first end 473 and an opposed second end 474, a tab side 475 from which a tab 476 extends and an opposed leg side 477 from which a first leg 478 having a base 479 and a second leg 480 having a base 481 extend. The blade safety insert 420 further includes a first side 482 and an opposed second side 483. At least one protrusion 484 extends from the second side 483, and preferably there are two protrusions 484, as shown in FIGS. 22-27. In a preferred embodiment there are two such protrusions 484, with one being formed each of the first and second legs 478, 480, respectively, and each having a generally rectangular shape. The blade safety insert 420 with protrusions 484 can be formed as a one piece unit. The protrusions 484 can be otherwise shaped. For example, they can be round, a dot or dots, polygon shaped, a curved or triangular shaped. It is pointed out that in other embodiments, the blade safety insert 420 can be formed such that the protrusions 484 extend from the first side 482 of the elongate body 472.

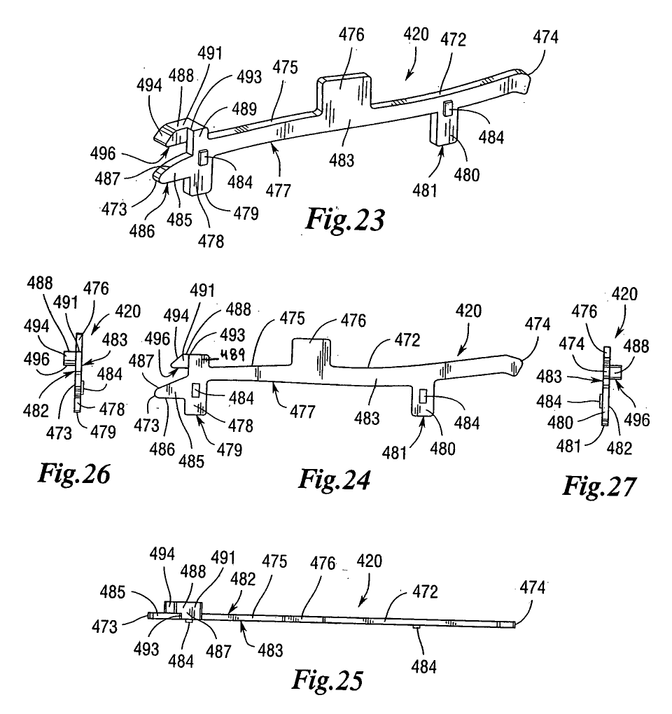

As shown in FIGS. 23 and 24, extending from the first leg 478 is a tang contact extension 485 that has a flat side 486 that meets with a curved side 487 at the first end 473 of the blade safety insert 420. The first insert end 473 abuts against the tang 438 of the first blade 430 when the blade safety insert 420 is introduced into the first blade cavity 460 of the folding knife 423.

As shown in FIGS. 22-27, a shoulder formation 488 extends from the from the tab side 475 of the blade safety insert 420. The shoulder formation 488 is proximal the first insert end 473 of the blade safety insert 420. The shoulder formation 488 includes a first shoulder portion having a first contact surface 493 that extends from the tab side 475 of the blade safety insert 420, as shown in FIGS. 22-26. As shown in FIGS. 23 and 24, the shoulder formation 488 extends from the blade safety insert 420 in the same direction that the tab 476 extends from the blade safety insert 420. As shown in FIG. 21, after the blade safety insert 420 has been introduced into the first blade cavity 460, the first blade 430 can be folded until the tang 438 thereof abuts against the first contact surface 493 of the shoulder formation 488, such that the first blade 430 is in a partially open position 490.

As shown in FIGS. 23 and 24, extending from the first shoulder portion 489 is a second shoulder portion 491 having a second shoulder contact surface 494. The second shoulder portion 491 extends from the first shoulder portion 489 in a direction opposite the direction the protrusions 484 extend from the from the second side 483 of the blade safety insert 420. After introduction of the blade safety insert 420 into the first blade cavity 460, the second shoulder portion 491 overhangs the second blade cavity 462, as shown in FIG. 21. The tang 428 of the second blade 432 abuts against the second contact surface 494 of the second shoulder portion 491 when the second blade 432 is in the partially open position, as shown in FIG. 21.

In use, the first and second blades 430, 432, respectfully are pivoted into the open position as shown in FIG. 22. The first and second legs 478, 480, respectively, are introduced into the first blade cavity 460, such that the protrusions 484 force against the third liner 444. The first end 473 of the blade safety insert 420 is proximal the tang 428 of the first blade 430 during introduction of the blade safety insert 422 into the first blade cavity 460. As the blade safety insert 420 continues to be introduced into the first blade cavity 460, the protrusions 484 provide a wedging type fit which holds the blade safety insert 420 in the first blade cavity 460. After introduction, the second blade 432 is closed until the tang 438 thereof abuts against the second contact surface 494 of the second portion 491 of the shoulder formation 488. Then, the first blade 430 is closed until the tang 438 thereof contacts the first contact surface 493 of the first portion 489 of the shoulder formation 488, such that the first and second blades, 430, 432, respectively, are in the partially open position.

As shown FIG. 21, after the blade safety insert 420 has been introduced into the folding knife 422 in the above-described manner, the second shoulder portion 491 overhangs the second blade cavity 462, and the first blade 430 makes an acute angle with the first blade cavity 460, and the second blade 432 makes an acute angle with the second blade cavity 462.

The acute angles can be varied by changing the distance between the first contact surface 493 and the second contact surface 494 and the first end 473 of the blade safety insert 420. For example, the greater the distance between the first end 473 and the first contact surface 493, and the first end 473 and the second contact surface 494 the smaller the acute angles.

In addition, the second shoulder portion 491 advantageously provides for a way, along with the tab 476, to manually overcome the friction or wedging type fit that the blade safety insert 420 makes with the second blade cavity 462. In particular, the shoulder formation 488 has a lifting surface 496 to which the user (not shown) manually applies a force, which causes the blade safety insert 420 to lift out of the second blade cavity 462. Thus, to remove the blade safety insert 420, the user can also pull on the tab 476 and apply a force on the lifting surface 496, causing the blade safety insert 420 to slide out of the first blade cavity 460.

In other preferred embodiments, the blade safety insert described herein can be shaped so that it can be received in virtually any folding knife cavity, regardless of the number of blades. In other embodiments, the blade safety insert could be made without the first and second support legs, 100, 102, respectively, or with a single support leg. In other embodiments, the tab 98 can be eliminated.

In addition, the blade safety insert 20 can be advantageously sold as part of a kit that includes the folding knife 22 and the blade safety insert 20 or any of the blade safety inserts described herein. The blade safety insert 20 can also be sold individually for use with pre-existing folding knives 22.

It will be appreciated by those skilled in the art that while a blade safety insert has been described above in connection with particular embodiments and examples, the invention is not necessarily so limited, and other embodiments, examples, uses, and modifications and departures from the described embodiments, examples, and uses may be made without departing from the blade safety insert of this invention. All of these embodiments are intended to be within the scope and spirit of the present blade safety insert invention.

What is claimed is:

1. In combination a folding knife and a blade safety insert for use therewith, the folding knife having a handle, a first blade having a tang pivotally connected to a first end of the handle for movement between an open position and a closed position, the handle having a first blade cavity therein adapted to receive the first blade when the first blade is folded into the fully closed position of the folding knife, and a spring biasing the first blade into the closed position, the blade safety insert being removably fitted within the first blade cavity, and the blade safety insert engaging the tang and blocking closing movement of the first blade beyond a pre-selected partially open position at an acute angle relative to the first blade cavity to prevent inadvertent closing movement of the first blade.

2. The combination according to claim 1 wherein the blade safety insert further includes a first side and an opposed second side and wherein at least one protrusion extends from the first side and the protrusion is for allowing the blade safety insert to be wedged in the first blade cavity such that the blade safety insert does not move when contacted by the tang of the first blade when the first blade is in the partially open position.

3. The combination according to claim 1 wherein the blade safety insert has a contact shoulder and the tang of the first blade contacts the contact shoulder when the first blade is in the partially open position.

4. The combination according to claim 1 wherein the blade safety insert has a lifting side and a lifting tab extends from the lifting side and the lifting tab is for allowing the blade safety insert to be manually removably fitted in the first blade cavity.

5. The combination according to claim 1 wherein the blade safety insert has a cavity side from which extends at least one leg and the at least one leg is for supporting the blade safety insert on the spring when the blade safety insert is removably fitted in the first blade cavity.

6. The combination according to claim 1 wherein the folding knife further includes a second blade having a tang pivotally connected to the first end of the handle for movement between an open position and a closed position relative thereto, and the handle having a second blade cavity adapted to receive the second blade when the second blade is folded into a fully closed position of the folding knife, and a second spring for biasing the second blade into the closed position, the blade safety insert having a formation for engaging the tangs of the first and second blades and blocking closing movement of the first and second blades beyond pre-selected partially open positions of acute angles relative to the first and second blade cavities to prevent inadvertent closing movement of the first and second blade.

7. The combination according to claim 6 wherein the formation includes a first portion against which the tang of the first blade abuts when in the partially open position, and the formation having a second portion against which the tang of the second blade abuts when in the partially open position and wherein the second portion of the formation overhangs the second blade cavity.

8. In combination a folding knife and a blade safety insert for use therewith, the folding knife having a handle, a first blade having a tang pivotally connected to a first end of the handle for movement between an open position and a closed position, a second blade having a tang pivotally connected to an opposite second end of the handle for movement between an open position and a closed position, the handle having a blade cavity therein adapted to receive the first and second blades when the latter are folded into the fully closed position of the folding knife, the blade safety insert being removably fitted within the blade cavity, the blade safety insert engaging the first and second blade tangs and blocking closing movement of the first and second blades beyond pre-selected partially open positions at acute angles relative to the blade cavity to prevent inadvertent closing movement of the first and second blades, and wherein the tangs of the first and second blades hold the blade safety insert in the blade cavity when in the partially open positions.

9. The combination according to claim 8 further comprising a spring biasing the first blade and the second blade into the closed position.

10. The combination according to claim 8 wherein the blade safety insert further includes a lifting side and an opposed cavity side and support legs extend from the cavity side and the support legs are for supporting the blade safety insert on the spring when the blade safety insert is removably fitted in the blade cavity.

11. The combination according to claim 10 wherein the blade safety insert further comprises a first liner side that is co-planar with the support legs and a second liner side that is co-planar with the support legs and wherein at least one protrusion extends from at least one of the first and second liner sides.

12. The combination according to claim 8 wherein the blade safety insert further has a first contact shoulder and an opposed second contact shoulder, such that the tang of the first blade contacts the first contact shoulder when the first blade is in the partially open position and the tang of the second blade contacts the second contact shoulder when the second blade is in the partially open position.

13. The combination according to claim 8 wherein the blade safety insert includes a lifting tab joined to the lifting side for allowing the blade safety to be removably fitted in the blade cavity.

14. In combination a folding knife and a blade safety insert for use therewith, the folding knife having a handle, a first blade and a third blade each having a tang pivotally connected to a first end of the handle for movement between an open position and a closed position, a second blade having a tang pivotally connected to an opposite second end of the handle for movement between an open position and a closed position, the handle having a blade cavity therein adapted to receive the first, second and third blades when the latter are folded into the fully closed position of the folding knife, the blade safety insert being removably fitted within the blade cavity, the blade safety insert engaging the first, second and third blade tangs and blocking closing movement of the first, second and third blades beyond pre-selected partially open positions at acute angles relative to the blade cavity to prevent inadvertent closing movement of the first, second and third blades, and wherein the tangs of the first, second and third blades hold the blade safety insert in the blade cavity when in the partially open positions

15. The combination according to claim 14 further comprising a first spring biasing the third blade into the closed position and a second spring biasing the opposed first and second blades into the closed position.

16. The combination according to claim 14 wherein the blade safety insert has a first contact shoulder that the tang of the third blade contacts when the third blade is in the partially open position, and further wherein the blade safety insert has a second contact shoulder that the tang of the second blade contacts when the second blade is in the partially open position, and wherein the first and second contact shoulders are offset from one another such that when the first and third blades are in the partially open position they are at different acute angles relative to the blade cavity.

17. The combination according to claim 16 wherein the blade safety insert has a third contact shoulder that the tang of the second blade contacts when the second blade is in the partially open position.
